(19) United States
(12) Patent Application Publication
(10) Pub. No.: US 2019/0350429 A1
(43) Pub. Date: Nov. 21, 2019

(54) Transformable cleaning sponge and method for utilization of same

(71) Applicant: Ken Lamont Joyner, Pasadena, CA (US)

(72) Inventor: Ken Lamont Joyner, Pasadena, CA (US)

(21) Appl. No.: 16/501,107

(22) Filed: Mar. 13, 2018

(51) Int. Cl. A47L 13/17; A47L 13/12; A47L 17/08; B08B 1/00

(52) U.S. Cl. CPC A47L 13/17; B08B 1/001; A47L 17/08; A47L 13/12

(57) ABSTRACT

A transformable cylindrical sponge 2 for washing dishes and cleaning surfaces 18. Multiple continuous insert slits 4&6 are cut from top end to bottom end for inserting various utensils 14 to clean. Abrasive scouring pad material 8 is adhered to both ends to enable effective cleaning. The sponge 2 can be flipped partially or completely inside-out for alternate cleaning of curved and non-curved surfaces 16 also enabling thorough cleaning and sanitization of the sponge 2. A utilization method is also included.

### FIELD OF THE INVENTION

This invention relates to kitchen cleaning sponges for manually cleaning all types of kitchen items like pots/pans, cups/glasses, utensils (forks, knives, spatulas and spoons), preparation surfaces (counters, tables, etc.) as well as any relevant equipment or apparatus (stoves, refrigerators, microwaves, etc.)

### BACKGROUND OF THE INVENTION

It is very common for people (consumers) to use kitchenware and drinkware (glasses/cups, pots/pans, forks/spoons/knives and various other types of utensils) as well as equipment and countertop surfaces to regularly prepare and consume food and beverages. After such preparation and consumption it is a routine task to clean the utensils in order to store and/or re-use as needed. The act of cleaning these various items is collectively referred to as “washing dishes”. It is also common to likewise wipe and clean relevant preparation surfaces like counters and tables as well as various equipment and fixtures.

Consumers normally rely on simple cleaning devices like towels/rags, sponges, scrubbers, scouring pads and other types of individual items which are common in the marketplace to clean these items.

Typically, the cleaning devices are distinct depending on the type of item you are cleaning. For example; glasses and cups are usually cleaned with dish towels or special apparatuses which have an elongated handle and some type of sponge or sponge like device on the end to enable the consumer to insert in glass/cup to reach the debris inside of the glass/cup. Separately, there are towels or sponges which are used to clean plates, pots/pans, knives/forks/spoons and other utensils as well as preparation surfaces and equipment. Further, there is often yet another separate abrasive type item used when extensive scrubbing or scouring of a particular item is needed (for example grimy pots, plates, pans, preparation surfaces or equipment with residual food or liquid firmly attached or embedded on the surface of a given item).

While the above products and methods are reasonably helpful to consumers, they can be tedious and problematic having to reach for multiple different types of cleaning devices while cleaning, depending on the particular item that is being cleaned as well as not significantly conforming to the specific contours of same. It can also be relatively expensive having to purchase multiple types of devices specifically for cleaning the various items.

Consequently, a single combined sponge and utilization method which is simple, convenient, efficient to use for cleaning relatively all the various items would be very beneficial and less expensive for dish washing consumers. Moreover, a sponge that is transformable to specifically address the cleaning requirements of each specific item would be better.

### SUMMARY OF THE INVENTION

The invention herein disclosed comprises a single, simple, compact, efficient, inexpensive and convenient manual sponge and method to effectively transform to clean all the various kitchen items. It will eliminate the need to purchase and reach for and use multiple unique apparatuses depending on the type of item to be cleaned. It will also better conform to the contours of same.

### DRAWINGS—FIGURES

FIG. 1 shows an elevational side view of the sponge.

FIG. 2 shows a top view of the sponge (same as bottom).

FIG. 3 shows a bottom view of the sponge (same as top).

FIG. 4 shows a transformed view of the sponge flipped partially inside-out.

FIG. 5 shows a transformed view of the sponge flipped completely inside-out.

FIG. 6 shows a view of the sponge in use cleaning a glass/cup.

FIG. 7 shows a view of the sponge in use cleaning a utensil (spoon).

FIG. 8 shows a view of the transformed sponge in use cleaning a bowl.

FIG. 9 shows a view of the transformed sponge in use scrubbing a surface (skillet).

FIG. 10 shows a view of the transformed sponge in use as a type of hand “mitt”.

### DRAWINGS—REFERENCE NUMERALS

2. Sponge
4. Continuous insert slit (top)
6. Continuous insert slit (bottom)
8. Abrasive scouring material (layer)
10. Human hand
12. Glass/cup
14. Utensil (spoon)
16. Bowl
18. Skillet/pan

### DETAILED DESCRIPTION

Sponge

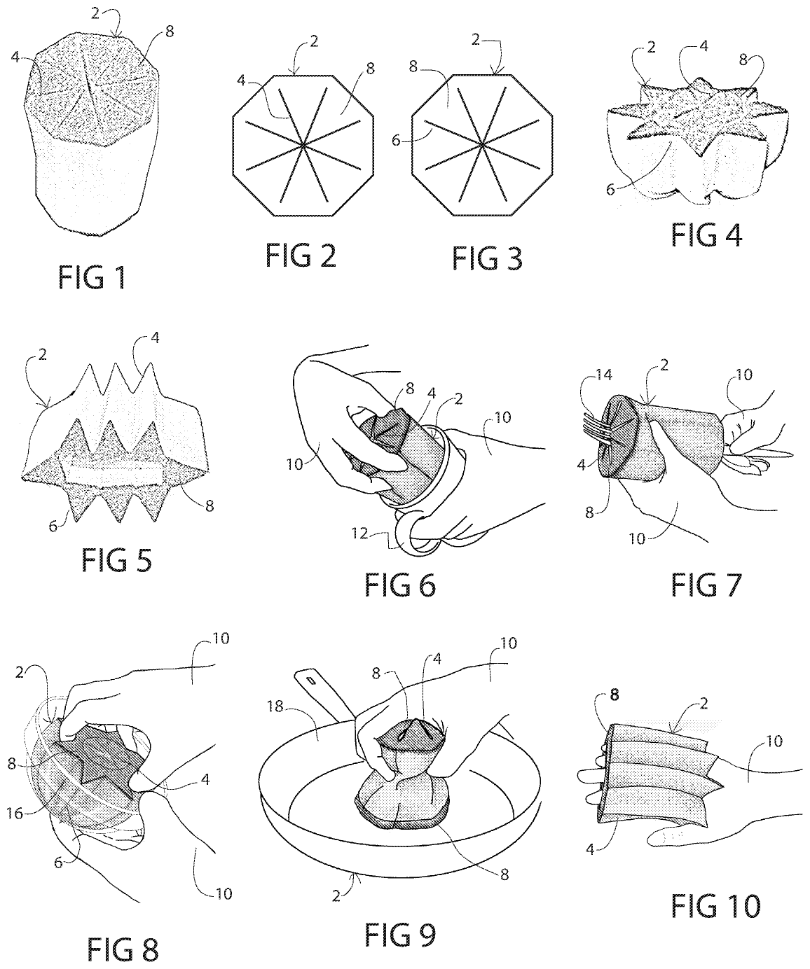

The invention sponge 2 is graphically illustrated in FIG. 1 through FIG. 5.

It is preferred (but not absolutely required) that the sponge 2 is cylindrical with matching ends (top and bottom) 4&6. It is preferred (but not absolutely required) that the cylinder is an octagonal shape having eight equal sides.

The outside circular dimension of the sponge 2 is of a predefined diameter which is small enough to effectively slide/slip within the interior surface of a glass/cup 12 or the like. Yet, the dimension is large enough to ensure the outside surface of the sponge 2 will effectively create agitation or friction to clean the surface of said cup or glass 12.

The length of the sponge 2 is of a predefined dimension which is long enough to effectively slip/slide into said glasses/cups 12 so the sponge 2 end will reach the bottom interior surface said glasses/cups 12. Yet, said predefined dimension is short enough to be effectively manipulated by hand 10 for cleaning.

An outside dimension of 68 millimeters and a length of 127 millimeters has proven to be effective dimensions (but not absolutely required).

It is preferred that the sponge has multiple slits 4&6 cut continuously through (top to bottom) to enable utensils 14 like forks, spoons, knives and spatulas or the like to be forcibly slipped therein or through to enable effective cleaning of the same. A quantity of eight evenly spaced slits 4&6 perpendicular to and strategically spaced from the intersecting corners of said eight equal sides has proven to be effective (but not absolutely required). It is preferred that both of the ends (top & bottom) 4&6 of the sponge 2 are finished with a substantial scouring or agitating material 18 operatively adhered to allow for effective deeper scrubbing of residual materials from items/surfaces to be cleaned 12,14,16 &18. Such a scouring material 8 is common and readily available in the industry. The above fabrication assembly/design would enable the sponge 2 to be manufactured more efficiently with a single die-cut. It should be noted that it is possible that die-cutting might affect the elongated tubular shape to be slightly askew which does not prevent the sponge 2 from functioning as required.

It is also preferred that the formed sponge 2 is made of a soft and flexible open-cell urethane or foam material which allows for substantial absorption of fluids as well as enables effective agitation of relevant surfaces when the sponge is forcibly rubbed or scrubbed against those surfaces 12,14,16 &18 in order to effectively clean the same.

The material formulation can also be antibacterial and/or antimicrobial which is a common option within the industry.

FIG. 4 shows the sponge 2 strategically flipped partially inside-out; done by using your fingers to forcibly push an end 4 or 6 of the sponge 2 so as to force it to collapse in on itself to the point where the interior surface are made to be on the outside (and vise-versa) to the extent desired to use the sponge 2 as an alternate means to clean kitchen items/surfaces 16 (particularly curved surfaces).

FIG. 5 shows the sponge 2 strategically flipped completely inside-out; done by using your fingers to forcibly push an end 4 or 6 of the sponge 2 so as to force it to collapse in on itself to the point where the interior surface is made to be on the outside (and vise-versa) to the fullest extent possible to use the sponge 2 as an alternate means to clean kitchen items/surfaces 16. This also enables the sponge 2 to be more thoroughly cleaned and sanitized inside-out either manually or via a dishwasher or washing machine if desired. It should be noted that the scouring ends can be utilized with all transformations of the sponge 2 as disclosed herein.

Method

The method is graphically indicated in FIG. 6 through 10.

FIG. 6 shows the sponge 2 as described above forcibly slipped or slid inside of a glass/cup 12. The sponge 2 is forcibly turned or twisted around within the glass/cup 12 to enable the exterior surfaces of the sponge 2 to clean the interior surface of the glass/cup 12 via agitation.

Alternatively, the glass/cup 12 can be forcibly turned around the sponge 2 instead to enable the same results. Any excessive residue, grime or grit which is settled in the bottom of the cup/glass can be abrasively removed by pushing downward on the sponge simultaneously while twisting.

FIG. 7 shows the sponge as described above with a utensil (spoon) 14 being forcibly slipped or slid inside of said sponge 2 via said formed insert slit(s) 4&6. The utensil 14 is forcibly turned or twisted around and or up and down within the sponge 2 while squeezing of the sponge 2 to enable the exterior surfaces of the utensil 14 to be cleaned by the interior slit 4&6 surface(s) of the sponge 2 via agitation. Alternatively, the sponge 2 can be forcibly slid over the utensil 14 and turned around the utensil 14 instead to enable the same results. Multiple utensils can be grasped and cleaned simultaneously if desired.

The sponge 2 can be grasped firmly in a way to enable the bottom or top 4&6 scouring surface 18 to be used as a scrubber for deeper cleaning of desired surfaces (e.g., pots, pans, dishes and counters).

The sponge 2 can also be grasped firmly in a way to enable the external side surfaces to be used to wipe clean the surfaces of larger flat or curved surfaces like plates, bowls, pots and pans, counters or the like.

FIG. 8 shows the way by which the sponge 2 can be forcibly flipped partially (halfway) inside-out to enable alternate means to clean and scour curved surfaces like bowls, pans and pots.

FIG. 5 shows the way by which the sponge 2 can be forcibly flipped completely inside-out and slipped over fingers as a type of “mitt” to enable cleaning of surfaces and further reaching of said surfaces. Like appliances, counters, tables and even walls and ceilings. It should be noted that the cleaning is not limited to cleaning equipment and surfaces, but rather any relevant surface including bathroom fixtures like tubs, showers, vanities, sinks and toilets.

Sponge 2 can be significantly cleaned and sanitized for continued safe use by flipping sponge 2 completely inside out to expose interior surfaces.

A cleaning solution/soap or the like can be applied to the surface(s) of the sponge 2 (for example applied within the slit(s) 4&6 or exterior surface) to facilitate more effective cleaning of the desired item(s).

While the above description contains much specificity, they should not be construed as limitations on the scope of the invention, but rather as exemplifications of the basic sponge and method thereof. Many other possible variations are obvious to individuals skilled in the sponge art.

For example:

The specific sponge design and material described can be altered and yet achieve the desired results as described.

The material can be compressed sponge (cellulose) and pop/expand into desired shape

Velcro (hook and loop) fastener(s) can be operatively connected to hang, store or compress sponge

The sponge dimensions and design can be modified to be fit multiple utensils.

The tubular shape can be designed to many various random or structured shape, yet achieve the same desired result.

The insert slits can be a singularly formed void or multiple voids rather than multiple slits.

The sponge material can be substantially anti-bacterial or anti-microbial or the like.

A clip or hanger can be formed or separately operatively attached to enable product to conveniently hang

The sponge can be designed to collapse for more efficient shipping, packaging and display space (for example).

The instructions or steps described can be performed to varying degree and/or in varying, order sequence or combination to achieve the desired end results described.

Thus the scope of the invention should be determined by the appended claims and their legal equivalents, rather than by the methods described and illustrated.

I claim:

1. A cleaning sponge that is transformable into specific functions for cleaning cup/glasses, dishes, pots/pans, relevant counter, wall and equipment surfaces which comprises;
a) an elongated cylinder having a top and bottom end which enables the user to methodically insert said sponge into a cup or a glass to enable effective cleaning within and without said cup or glass,
b) at least one formed slit which runs entire length of sponge to enable at least one utensil to be methodically inserted into said sponge to enable external surface of said utensil to be methodically cleaned by said sponge
c) an abrasive material operatively adhered to said bottom and/or top end which enable effective scrubbing or scouring away of surface residue.

2. The apparatus of claim 1; wherein said formed slits enable sponge to be turned halfway inside-out and thereby forming a curved end which conforms to the shape of curved bowls, pots, and pans or the like for effective cleaning of same.

3. The apparatus of claim 1; wherein said formed slits enable sponge to be turned completely inside-out and thereby forming a partial mitten to slip over fingers on one hand for effective reaching and cleaning of surfaces desired to be cleaned.

4. The apparatus of claim 3; which further enables said sponge to be maximally exposed for thorough cleaning and sanitized of said sponge as needed.

5. The apparatus of claim 1; wherein said sponge is fabricated from a single die-cut.

6. The apparatus of claim 1, wherein said cylinder is octagonal

7. The apparatus of claim 7, wherein there is a said slit centered perpendicularly on each of the eight octagon sides

8. The apparatus of claim 1; wherein said sponge is antibacterial

9. The apparatus of claim 1; wherein said sponge is antimicrobial

10. A method for cleaning with a sponge which comprises;
Strategically inserting a cleaning sponge that is transformable into specific functions for cleaning cup/glasses, dishes, pots/pans, relevant counter, wall and equipment surfaces which comprises;
a) an elongated cylinder having a top and bottom end which enables the user to methodically insert said sponge into a cup or a glass to enable effective cleaning within and without said cup or glass,
b) at least one formed slit which runs entire length of sponge to enable at least one utensil to be methodically inserted into said sponge to enable external surface of said utensil to be methodically cleaned by said sponge
c) an abrasive material operatively adhered to said bottom and/or top end which enable effective scrubbing or scouring away of surface residue.

11. The method of claim 10; further comprising strategically manipulating said sponge within said drinkware thereby effectively cleaning said drinkware.

12. The method of claim 10; further comprising strategically inserting said utensils into said at least one slit in sponge.

13. The method of claim 12; further comprising strategically manipulating said utensil to enable at least one surface of said sponge to cause friction against said utensil thereby cleaning said kitchenware.

14. The method of claim 12; further comprising strategically manipulating said sponge to enable at least one surface of said utensils to cause friction against said utensils thereby cleaning said kitchenware.

15. The method of claim 10; further comprising wetting said sponge with water or the like.

16. The method of claim 10; further comprising infusing said sponge with a cleaning soap or the like.

17. The method of claim 16; wherein said infusing is via said at least one insertion slit.

18. The method of claim 10; further comprising utilizing an operatively adhered scouring means or the like on said sponge to abrasively clean said surfaces.

19. The method of claim 10; further comprising flipping said sponge partially inside-out to enable effective cleaning and scouring of curved surfaces.

20. The method of claim 10; further comprising flipping said sponge completely inside-out to enable effective cleaning and scouring of kitchen surfaces as well as thorough cleaning and sanitization of said sponge.
